(19) United States
(12) Patent Application Publication
(10) Pub. No.: US 2020/0318263 A1
(43) Pub. Date: Oct. 8, 2020

(54) MANAGEMENT OF SPOOLS OF THREADS IN TEXTILE MACHINES

(71) Applicant: BSE DI BIANCARDI GUGLIELMO & C. S.A.S., Castel Goffredo (IT)

(72) Inventor: Michele BIANCARDI, Castel Goffredo (IT)

(73) Assignee: BSE DI BIANCARDI GUGLIELMO & C. S.A.S., Castel Goffredo (IT)

(21) Appl. No.: 16/956,902

(22) PCT Filed: Dec. 20, 2018
(86) PCT No.: PCT/IB2018/060409

§ 371 Date: Jun. 22, 2020

(30) Foreign Application Priority Data
Dec. 22, 2017 (IT) 102017000148713

(51) Int. Cl. D03J 1/00; B65H 67/06; G06K 7/10; G06K 19/07

(52) U.S. Cl. CPC D03J 1/00; B65H 67/063; B65H 2701/31; G06K 19/0723; G06K 7/10366

(57) ABSTRACT

A weaving apparatus using devices for the processing and/or treatment of threads or yarns, comprising a system for the management of threads or yarns. The spools are associated with a respective marker and the apparatus comprises at least one reader of the marker, a storage device functionally associated with the at least one reader being provided.

The present invention relates to a weaving apparatus which uses devices for the processing and/or treatment of yarns or threads.

An important problem that is common to all weaving apparatuses, for example for the production of hosiery and stockings, resides in the difficulty in managing correctly and adequately the spools of yarn along the entire apparatus.

Specifically, spools (of the different types) are currently purchased and stored within a storage unit.Prior to their use, they are generally transferred inside the building in which the machines are arranged in order to ensure their correct acclimatization.

As the spores on the individual machines progressively deplete, the operator replaces them with spools of the same type already allocated in the shed.

The management of the spools described briefly above has various critical aspects.

First of all, it is not possible to control precisely whether the spools that in each instance are fed to the machines are conditioned correctly and actually correspond to the type of yarn or thread required.

Furthermore, a certain difficulty in managing orders and controlling the quantity of the threads or yarns used to provide the various types of textile products is observed.

The aim of the present invention is to provide a system for managing spools of threads or yarns, particularly in weaving apparatuses that use devices for the processing and/or treatment of threads or yarns, that is capable of improving the background art in one or more of the aspects indicated above.

Within the scope of this aim, an object of the invention is to provide a system for managing spools of threads or yarns, particularly in weaving apparatuses, that allows to manage in an automated manner the spools to be used.

Another object of the invention is to allow real-time control of the types and quantities of thread and/or yarn in store and on the machines.

Another object of the invention is to provide a system for managing spools of threads or yarns, particularly in weaving apparatuses, that is highly reliable, relatively easy to provide and at competitive costs.

This aim, these objects and others which will become better apparent hereinafter are achieved by a system for managing spools of threads or yarns, particularly in weaving apparatuses using devices for the processing and/or treatment of threads or yarns according to claim 1, optionally provided with one or more of the characteristics of the dependent claims.

Further characteristics and advantages of the invention will become better apparent from the description of some preferred but not exclusive embodiments of weaving apparatuses using devices for the processing and/or treatment of threads or yarns according to the invention, illustrated by way of nonlimiting example in the accompanying drawings, wherein:

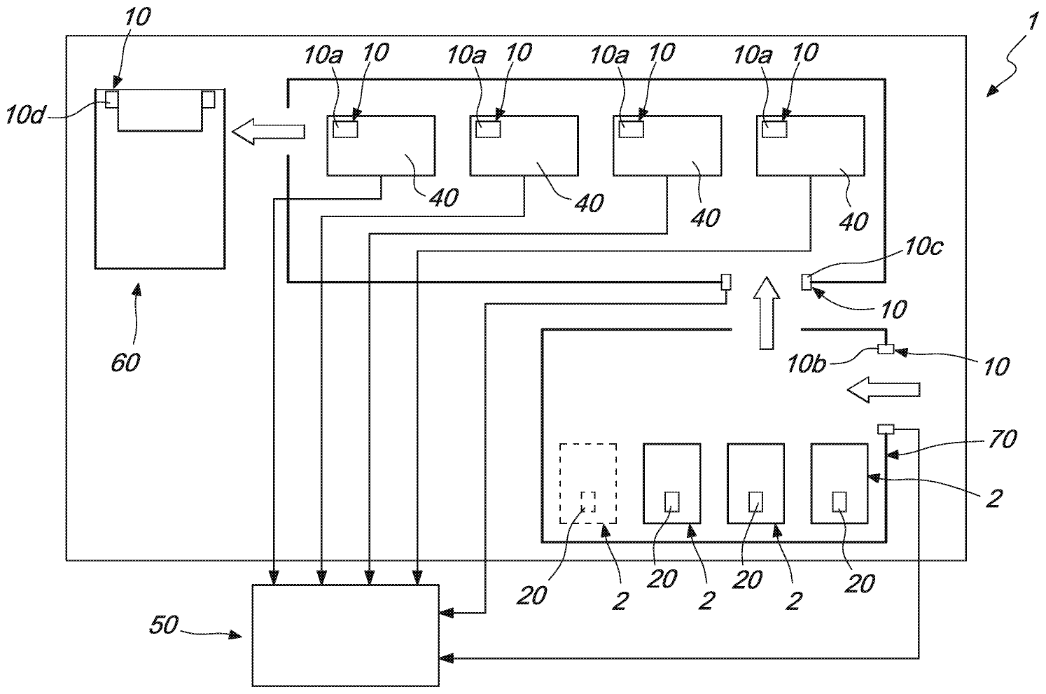

FIG. 1 is a schematic view of a practical embodiment of the system.

With reference to the figure, the system for managing spools of threads or yarns, particularly in weaving apparatuses using devices for the processing and/or treatment of threads or yarns, generally designated by the reference numeral 1, comprises spools of thread or yarn 2 which are associated with a respective marker 20.

The apparatus 1 furthermore comprises at least one reader 10 of the marker 20.

The apparatus 1 comprises a storage device 50 which is functionally associated with the reader or readers 10.

Preferably, the reader 10 comprises first readers 10a which are functionally associated with a spool weighing device.

In particular, said first readers 10a are functionally associated with a device for the processing and/or treatment of threads or yarns, such as for example a circular or rectilinear textile machine 40 for the production of hosiery items, sheets and items of clothing in general, generally termed textile items.

According to the present invention, the system for managing spools of threads or yarns comprises at least one second reader 10b which is arranged at a respective opening for access to a storage unit 70.

Advantageously, the system for managing spools 2 of threads or yarns has at least one third reader 10c which is arranged at a respective opening for access to a conditioning area 30.

With particular reference to the presence of the second reader or readers 10b, and optionally of the third reader or readers 10c, it is noted that it is possible to configure them to also read markers 20a arranged on a package of spools 2 of threads or yarns.

Preferably, the marker 20 associated with each spool of thread or yarn has a plurality of identification data of the thread or yarn wound on the respective spool which are chosen from the group comprising:
the type of thread or yarn;
the weight of the thread or yarn wound on the spool;
the production batch of the yarn or of said thread.

Conveniently, the system for managing spools of threads or yarns comprises a computer which is functionally connected to the readers.

The computer 50 in particular is adapted to store the data acquired by the readers 10.

According to a preferred embodiment, the marker 20 is of the RFID type.

In this case, the reader or readers comprise a respective reader of markers of the RFID type.

The markers of the RFID type can be in particular associated with the central body of the spool around which the thread or yarn is wound.

In this regard, the marker may be associated stably, for example by adhesive bonding, with the central body or may be integrated or embedded within the central body.

The marker can be of the rewritable or non-rewritable type.

The weaving apparatus 1 has a management system inside which the typical processing parameters of the individual types of thread are stored.

For example, said processing parameters comprise the type of thread or yarn that must be fed to each spool support of each machine, the time required for the conditioning of each type of thread or yarn, the weight or the quantity of thread or yarn required to produce a predetermined number of textile products, and so forth.

The management system is capable of checking the actual match between the processing parameters detected by the readers with the ones stored in the management system.

The computer is functionally associated or associable with a data loading device, which can be accessed by the spool suppliers.

This allows to have precise control both of the spools of the various types that are present in the apparatus and of the ordered ones, in order to be able to manage supply operations automatically or semiautomatically.

The system may also comprise a fourth reader 10d arranged at a container 60 (constituted for example by a bag or a box) for the unloading of the central bodies of the spools (with which the marker is associated).

Said fourth reader 10d allows to monitor the depletion of the spools 20.

The fourth reader 10d can also be functionally associated with means for weighing the central bodies of the spools and any yarn that is still wound thereon.

The system may furthermore provide the possibility to associate a further marker element with a container of the manufactured textile items.

The container comprises, for example, a bag or a box.

The additional marker can be of the rewritable type or, more generally, can be associated, automatically or semiautomatically, with the information related to the process for the production of the textile products contained in the respective container and, specifically, detected by the various readers 10.

In practice it has been found that the invention achieves the intended aim and objects.

The invention thus conceived is susceptible of numerous modifications and variations, all of which are within the scope of the accompanying claims; all the details may furthermore be replaced with other technically equivalent elements.

In practice, the materials used, so long as they are compatible with the specific use, as well as the contingent shapes and dimensions, may be any according to the requirements and the state of the art.

The disclosures in Italian Patent Application no. 102017000148713, from which this application claims priority, are incorporated herein by reference.

1.-8. (canceled)

9. A weaving apparatus using devices for the processing and/or treatment of threads or yarns, comprising a system for the management of spools of threads or yarns, wherein said spools are associated with a respective marker, said apparatus comprising at least one reader of said marker, a storage device functionally associated with said at least one reader and a computer functionally connected to said readers and adapted to store the data acquired by said at least one reader being provided, said reader comprising first readers functionally associated with a device for weighing said spool.

10. The apparatus according to claim 9, wherein said first readers are functionally associated with a device for the processing and/or treatment of threads or yarns.

11. The apparatus according to claim 9, wherein said reader comprises at least one second reader arranged at a respective opening for access to a storage unit.

12. The apparatus according to claim 11, wherein said reader comprises at least one third reader arranged at a respective opening for access to a conditioning area.

13. The apparatus according to claim 9, wherein said marker has a plurality of data items which identify the yarn wound on the respective spool, chosen in the group comprising:
a type of thread or yarn;
a weight of the thread or yarn wound on said spool;
a production batch of said thread or of said yarn.

14. The apparatus according to claim 9, wherein said marker is of the RFID type and said at least one reader comprises a reading module of the RFID type.

15. The apparatus according to claim 9, wherein said weaving apparatus comprises a management system within which typical processing parameters of the individual types of thread are stored, said management system being configured to check an actual match between the processing parameters detected by said readers and the processing parameters stored in the management system.

16. The apparatus according to claim 9, wherein said computer is functionally associated or associable with a data loading device which can be accessed by spool suppliers.
